(19) United States
(12) Patent Application Publication
(10) Pub. No.: US 2017/0104955 A1
(43) Pub. Date: Apr. 13, 2017

(54) Multi purpose broadcast TV device

(71) Applicant: Michael Lewis Moravitz, Fairfax, VA (US)

(72) Inventor: Michael Lewis Moravitz, Fairfax, VA (US)

(21) Appl. No.: 14/999,200

(22) Filed: Apr. 11, 2016

(51) Int. Cl. H04N 5/91; H04N 5/907; H04N 21/4147; H04N 5/85

(52) U.S. Cl. CPC H04N 5/91; H04N 5/85; H04N 5/907; H04N 21/4147

(57) ABSTRACT

A digital video recorder can be engineered and manufactured for broadcast (analog) television in which programs could be recorded and played on the television—perhaps even in connection to a traditional compact disc player.

A multi-purpose device can be engineered and manufactured for broadcast television to record programs through a digital video recording system. Analog can of course be digitized. This broadcast TV DVR would allow customers with broadcast television to record without a taping system—a vast improvement of both quality, efficiency, and ease of usage.

Perhaps this multi-purpose device could be combined with a DVD player so that one could record digitally onto memory chips in the system along with playing commercial discs. This might also incorporate my previous patent for a DVD player that would record onto a blank disc. A customer might want to record analog to digital and then transfer to a disc for sharing or for a personal collection. This would break through certain compatibility issues and bring down costs for home entertainment. Intellectual property rights laws would still apply, of course.

1) Builds on patents for DVRs;

2) TiVo;

3) Compact disc players;

4) And my previous patent for a DVD player that records (29/463,839).
